(19) United States
(12) Patent Application Publication
(10) Pub. No.: US 2025/0279680 A1
(43) Pub. Date: Sep. 4, 2025

(54) Additively Manufactured Magnetic Lamination

(71) Applicant: Siemens Aktiengesellschaft, München (DE)

(72) Inventors: Carsten Schuh, Baldham (DE); Rolf Vollmer, Gersfeld (DE)

(73) Assignee: Siemens Aktiengesellschaft, München (DE)

(21) Appl. No.: 18/858,654

(22) PCT Filed: Apr. 19, 2023
(86) PCT No.: PCT/EP2023/060084

§ 371 Date: Oct. 21, 2024

(30) Foreign Application Priority Data
Apr. 27, 2022 (EP) 22170312.7

(51) Int. Cl. H02K 1/02; B22F 10/10; B22F 10/64; B33Y 10/00; B33Y 40/20; B33Y 80/00; C22C 38/40; H02K 1/24; H02K 15/022

(52) U.S. Cl. CPC H02K 1/02; B22F 10/10; B22F 10/64; B33Y 10/00; B33Y 40/20; B33Y 80/00; C22C 38/40; H02K 1/24; H02K 15/022; B22F 2301/35; B22F 2998/10; B22F 2999/00; C22C 2202/02

(57) ABSTRACT

Various embodiments of the teachings herein include an additively produced magnetic lamination for a laminated core of an electric machine. An example includes at least three layers connected by sintering, wherein each layer contains at least two material components separate from one another in planar extent. The arrangement of the material components in their planar extent in a respective layer is symmetrical to a center plane of the magnetic lamination. A ratio of material contents of the first material component and of the second material component is modified over the layer sequence. The first material component is arranged in a radially inner region of the respective layer and the second material component is arranged in a radially outer region of a respective layer. The first material component comprises an iron alloy with an austenitic microstructure of at least 25% by volume.

### CROSS-REFERENCE TO RELATED APPLICATIONS

This application is a U.S. National Stage Application of International Application No. PCT/EP2023/060084 filed Apr. 19, 2023, which designates the United States of America, and claims priority to EP application Ser. No. 22170312.7 filed Apr. 27, 2022, the contents of which are hereby incorporated by reference in their entirety.

### TECHNICAL FIELD

The present disclosure relates to additive manufacturing. Various embodiments of the teachings herein include systems and/or methods for additive production of a magnetic lamination.

### BACKGROUND

Screen printing or stencil printing typically includes pressing a printing paste onto a substrate by means of a stencil, the open regions of which may also be provided with a screen. Reference is made in this respect to stencil printing or screen printing, stencil printing being an umbrella term covering screen printing. In addition to solvents and/or binders, the printing paste contains metal powders, which have a functional action in the resulting component. The screen printing technique results in production of a green body, which after a further heat treatment firstly generally has the binder removed and then is fed to a sintering process at a higher temperature, the metallic powder grains being sintered to one another such that a structured lamination, the magnetic lamination, is produced.

To achieve a higher mechanical strength of such laminations, in particular in the case of high rotor speeds in electric machines, the producibility of two-component magnetic laminations is becoming increasingly important. An example for this is described in EP 3723249 A1. A fundamental problem with such two-component magnetic laminations produced by stencil printing is that the different materials, if they for the one part have good magnetic properties and for the other part have a high strength, generally have different coefficients of thermal expansion. Thus, for example, a high-strength steel constituting a subcomponent for the mechanical strength of the magnetic lamination has a coefficient of expansion of 16×10⁻⁶ K⁻¹. A further soft-magnetic material in this respect has a coefficient of thermal expansion of between 10-12×10⁻⁶ K⁻¹ in a temperature range between 0 and 100° C. During the joint sintering of such different material components, or material pairs, in a green body to afford a magnetic lamination, high mechanical stresses form in the connecting, or seam, regions between these material components owing to these different coefficients of thermal expansion, in particular when the sintering temperatures are being cooled down to room temperature. This can lead to bulges or to cracks or overall to mechanical stresses in the magnetic lamination, which can significantly impair the mechanical or magnetic properties.

### SUMMARY

The teachings of the present disclosure include a magnetic lamination and a method for producing a magnetic lamination, and from this to generate a laminated core and an electric machine, in the case of both of which the magnetic lamination has a higher strength and fewer intrinsic stresses than the prior art in the event of use of at least two material components within the magnetic lamination. For example, some embodiments of the teachings herein include an additively produced magnetic lamination (2), for a laminated core (4) of an electric machine (6), which comprises at least three layers (8-1, 8-2, 8-3 . . . 8-n) connected by sintering, wherein each layer (8-1, 8-2, 8-3 . . . 8-n) contains at least two material components (10-1), (10-2) separate from one another in planar extent, characterized in that the arrangement of the material components (10-1), (10-2) in their planar extent in a respective layer (8-1, 8-2, 8-3 . . . 8-n) is symmetrical to a center plane (12) of the magnetic lamination (2), wherein a ratio of material contents of the first material component and of the second material component is modified over the layer sequence and the first material component (10-1) is arranged in a radially inner region (14) of the respective layer (8-1, 8-2, 8-3 . . . 8-n) and the second material component (10-2) is arranged in a radially outer region (16) of a respective layer (8-1, 8-2, 8-3 . . . 8-n) and the first material component (10-1) comprises an iron alloy, which has an austenitic microstructure to an extent of at least 25% by volume.

In some embodiments, the second material component (10-2) comprises an iron alloy, which comprises at least 95% by weight, in particular at least 97% by weight iron.

In some embodiments, the second material component (10-2) has a ferritic or martensitic microstructure.

In some embodiments, the first material component (10-1) is a chromium-nickel alloy.

In some embodiments, the first material component (10-1) is an iron-chromium alloy, with a chromium content of between 22% by weight and 28% by weight, in particular between 24% by weight and 26% by weight.

In some embodiments, the first material component (10-1) has a nickel content of between 4% by weight and 10% by weight, in particular between 6% by weight and 8% by weight.

In some embodiments, at least one layer (8-1, 8-2, 8-3 . . . 8-n) has a transition region (18) between the radially inner region (14) and the radially outer region (16), which contains both the first material component (10-1) and the second material component (10-2) in discrete subregions (20).

In some embodiments, a lower outer layer (22-1) and an upper outer layer (22-2) of the magnetic lamination are each formed only by the radially inner region (14) and by the radially outer region (16).

In some embodiments, the individual layers (8-1, 8-2, 8-3 . . . 8-n) of the magnetic lamination (2) have different layer thicknesses (24).

In some embodiments, individual layers (8-1, 8-2, 8-3 . . . 8-n) have layer thicknesses (24) of between 10 μm and 80 μm.

As another example, some embodiments include a method for producing a rotationally symmetrical magnetic lamination (2) for a laminated core (4) of an electric machine (6), comprising: a) applying a first printing paste (26-1) by a stencil printing method (28) to a substrate (30) in order to form a first region (34-1) of a first layer (32-1), b) applying a second region (34-2) of the first layer (32-1) to the substrate (30) using a second printing paste (26-2), with the result that a radially inner print region (36) and a radially outer print region (38) are formed in the layer, c) repeating steps a) to c), with the result that at least three layers (32-1, 32-2, 32-3, . . . , 32-n) that form a green body (40) of the magnetic lamination (2) are produced, wherein d) the first printing paste (26-1) and the second printing paste (26-2) comprise different functional material starting components and the functional material starting components of the two printing pastes comprise iron particles in different alloy compositions and e) the arrangement of the print regions (34-1, 34-2) in the individual layers (32-1, 32-2, 32-3, . . . , 32-n) is configured such that a symmetry of the regions (34-1, 34-2) with respect to a center plane (12), which runs parallel to the substrate (30) through the middle of the green body (40), is provided and the material contents of the printing pastes vary between the individual layers, f) carrying out a sintering process (42) on the green body (40) to form the magnetic lamination (2), with the result that radially inner print regions (36), which at least partially have an austenitic microstructure, of the green body (40) are converted into an iron-based material component (10-1) in the magnetic lamination (2).

In some embodiments, in addition to the radially inner print region (36) and the radially outer print regions (38), transition print regions containing both the first material starting component and the second material starting component in discrete subregions (46) are created in at least two layers (32-1, 32-2, 32-3, . . . , 32-n).

In some embodiments, at least one material component is applied in the transition print region by a printing-free additive manufacturing method, in particular a spraying method.

As another example, some embodiments include a laminated core for a rotor (48) of an electric machine (6), comprising a plurality of magnetic laminations (2) as described herein.

As another example, some embodiments include an electric machine comprising a laminated core (4) as described herein.

### BRIEF DESCRIPTION OF THE DRAWINGS

Further embodiments of the teachings herein and further features are described in more detail with reference to the following figures. The figures are purely schematic illustrations that do not represent a restriction of the scope of protection. In the case of features that have a different embodiment but bear the same designation, the respective same reference sign is used in the individual figures. In the figures:

FIG. 1 shows a schematic exploded illustration of an electric machine, in particular an electric motor, comprising a housing, a stator and a rotor, which is mounted on a shaft incorporating teachings of the present disclosure;

FIG. 2 shows a typical laminated core for a rotor of an electric machine incorporating teachings of the present disclosure;

FIG. 3 shows an example of a layer structure of individual layers of a magnetic lamination incorporating teachings of the present disclosure;

FIG. 4 shows a layer structure of a magnetic lamination incorporating teachings of the present disclosure;

FIG. 5 shows a layer structure of a magnetic lamination incorporating teachings of the present disclosure;

FIG. 6 shows a plan view of a magnetic lamination, or a section through a magnetic lamination, with three regions of the material components incorporating teachings of the present disclosure;

FIG. 7 shows a section through a magnetic lamination as in FIG. 6 incorporating teachings of the present disclosure; and

FIG. 8 shows a method sequence incorporating teachings of the present disclosure for producing a magnetic lamination.

### DETAILED DESCRIPTION

An example additively produced magnetic lamination for a laminated core of an electric machine incorporating teachings of the present disclosure comprises at least three layers connected by sintering, wherein each layer has at least two material components separate from one another in planar extent. The arrangement of the material components in their planar extent in a respective layer is symmetrical to a center plane of the magnetic lamination, wherein a ratio of material contents of the first material component and of the second material component is modified over the layer sequence. In this respect, the first material component is arranged in a radially inner region of the respective layer and the second material component is arranged in a radially outer region of a respective layer. The first material component comprises an iron alloy, which has an austenitic microstructure to an extent of at least 25% by volume in the magnetic lamination. The magnetic lamination is constructed from multiple varying layers in the form of a laminate, although the layers are fixedly connected to one another by a sintered connection and the material contents of the material components in each layer vary. This makes it possible to compensate for stresses that are created owing to different coefficients of thermal expansion of the individual material components.

The magnetic lamination produced in this way also therefore has a higher mechanical stability, since the material component which is radially on the inside has an austenitic microstructure and thus intrinsically has a higher mechanical strength. For the reduction in the stresses occurring owing to the different coefficients of expansion, it is also important for the individual layers to be provided with a symmetry. Thus, with respect to the lamination in the lamination plane, a plane of symmetry running exactly halfway up the magnetic lamination is defined. The material content of the individual material components above and below the plane of symmetry is the same in this case. This serves primarily to ensure that, owing to the coefficients of expansion, not only are the stresses dissipated but the magnetic lamination also has less of a tendency to bulge.

In some embodiments, the second material component is an iron alloy, which comprises at least 95% by weight, in particular at least 97% by weight or at least 99% by weight iron. In some embodiments, this is pure iron, since pure iron has the best ferritic microstructure or martensitic microstructure and thus comprises very good soft-magnetic properties that are advantageous for the respective reversal in magnetization in an electric machine.

In some embodiments, the first material component in the radially inner region of the magnetic lamination is configured such that it has as high a strength as possible and withstands the mechanical loading acting on the magnetic lamination. For this, in particular a chromium-nickel alloy is expedient as starting material for the first material component. This chromium-nickel alloy may have a chromium content of between 22% by weight and 28% by weight, in particular between 24% by weight and 26% by weight.

In some embodiments, the nickel content is between 4% by weight and 10% by weight, in particular between 6% by weight and 8% by weight, the reference values each being included in the range indicated.

In some embodiments, at least one layer is provided with a transition region, which is arranged between the radially inner region and the radially outer region. The transition region contains both the first material component and the second material component in discrete subregions. The expression “discrete subregions” is understood in this case to mean that the transition region does not contain a mixture of the individual material components, but rather that, in the transition region in certain portions, regions with the first material component and the second material component are present separately, which is to say discretely, from one another.

In this respect, the individual material components in the transition region may be arranged both contiguously on the inner or outer region or be present in the form of islands within the respective other material component. The transition region with the respective described discrete subregions of the individual material components is particularly suitable for adapting the different coefficients of thermal expansion to one another. The absolute expansion on heating during operation or in the event of sintering shrinkage is smaller in itself in the case of the described smaller discrete subregions than in the case of larger regions. Calculation, for example using finite elements, makes it possible to ascertain a suitable structure of the discrete subregions in the transition region and thus also minimize the stresses within the magnetic lamination again by using the described finite element method.

When this transition region is applied, however, it may be expedient to configure an upper outer layer of the magnetic lamination and a lower outer layer of the magnetic lamination such that they have no transition region and are formed only by the radially inner region and by the radially outer region. This affords the advantage that magnetic shielding is ensured for the transition region of the inner layers, with the result that magnetic regions in the radially inner region, which in itself is not magnetic, do not lead to eddy current losses.

To better adapt the coefficients of thermal expansion within the magnetic lamination, it may also be expedient for the individual layers to have different layer thicknesses. Depending on the number of layers that form a respective magnetic lamination, this usually is between three layers and nine layers, the layer thicknesses of the individual layers may have layer thicknesses of between 10 μm and 80 μm, in particular between 20 μm and 50 μm.

Some examples include a method for producing a rotationally symmetrical magnetic lamination for a laminated core of an electric machine comprising:
a) applying a first printing paste by a stencil printing method to a substrate in order to form a first region of a first layer,
b) applying a second region of the first layer to the substrate using a second printing paste, with the result that a radially inner print region and a radially outer print region are formed in the layer,
c) repeating steps a)-c), with the result that at least three layers that form a green body of the magnetic lamination are produced, wherein
d) the first printing paste and the second printing paste comprise different functional material starting components and the functional material starting components of the two printing pastes comprise iron particles in different alloy compositions and
e) the arrangement of the print regions in the individual steps is configured such that there is a symmetry of the regions with respect to a center plane, which runs parallel to the substrate through the middle of the green body, and the material contents of the printing paste vary between the individual layers,
f) carrying out a sintering process on the green body to form the magnetic lamination, with the result that radially inner print regions, which at least partially have an austenitic microstructure, of the green body are converted into an iron-based material component in the magnetic lamination.

In general, the incorporation of a drying step between steps b) and c) may be expedient, but not necessary in all cases and depends on the viscosity and moisture content of the printing paste.

For analysis of phase components, in particular for determination of an austenitic microstructure proportion, a planar section is made through the material and evaluated with a reflected light microscope using image processing software. For the image processing, it is possible to use, for example, both a Zeiss microscope and the associated ZEN software. In this respect, an advantageous austenitic-microstructure proportion is considered to be at least 25% by volume. For microstructure proportions, proportions by volume are used as measured variable owing to the evaluation using a planar section and a two-dimensional image. For the specification of alloy constituents, % by weight are used, since in this case the admixing of the individual components can advantageously be measured in proportions by weight.

In some embodiments, in addition to the radially inner print region and the radially outer print region, transition print regions containing both the first material starting component and the second material starting component in discrete subregions are created in at least two layers. This has also already been described with respect to the magnetic lamination; as a result, the effects of the different coefficients of expansion of the individual material components are again further reduced. In particular if the transition print regions contain representations of island-like discrete subregions, it may be procedurally complex to imprint a material component into an already printed material component. In this case, it may be expedient to use a printing-free additive manufacturing method, in particular a spraying method, for the representation of the second printing material starting component, in particular in island regions.

Some embodiments include a laminated core for a rotor of an electric machine, comprising a plurality of magnetic laminations as described herein and/or produced by a method as described herein. Some embodiments include an electric machine with such a laminated core as described herein.

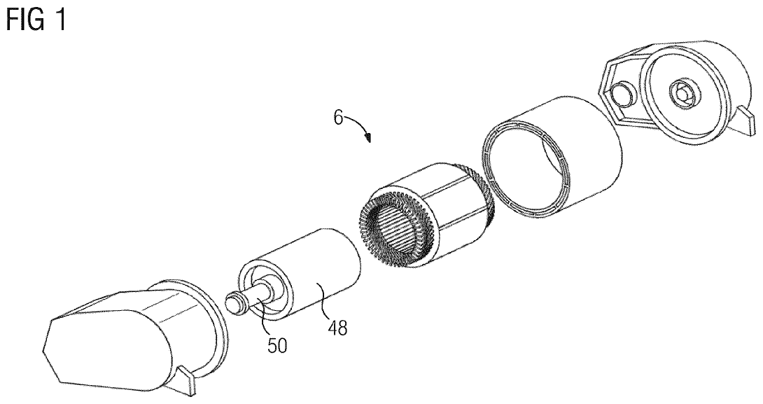

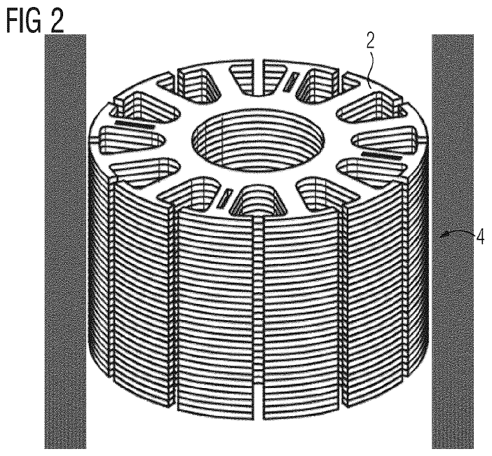

FIG. 1 shows an exploded illustration of an electric machine 6, in this case in the form of an electric motor incorporating teachings of the present disclosure, for example for an electric vehicle. The individual components of the electric machine 6 will not be addressed in detail at this point. What is designated, however, is a rotor 48, which is mounted on a shaft 50. In this respect, the rotor 48 comprises a laminated core 4, which is illustrated more specifically and in more detail in FIG. 2, with the laminated core 4 being composed of a stack of individual magnetic laminations 2. In the position of installation in the rotor 48, the laminated core 4 is surrounded by windings, which are not illustrated here.

FIG. 2 shows that the magnetic laminations 2 are structured planar entities, the term “planar” being understood to mean that a flat extent is involved, the extent of the magnetic lamination in the lamination plane being considerably greater than a height 64 of the magnetic lamination 2. The areal extent, i.e. the diameter of the magnetic lamination 2, is preferably at least five times greater than the height 64.

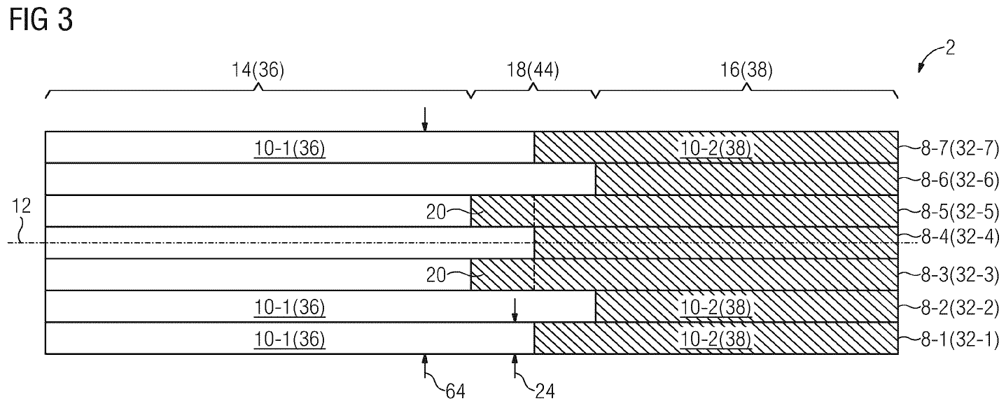

FIG. 3 shows a schematic illustration through a section of a magnetic lamination 2. It shows only one side of the rotationally symmetrical magnetic lamination 2.

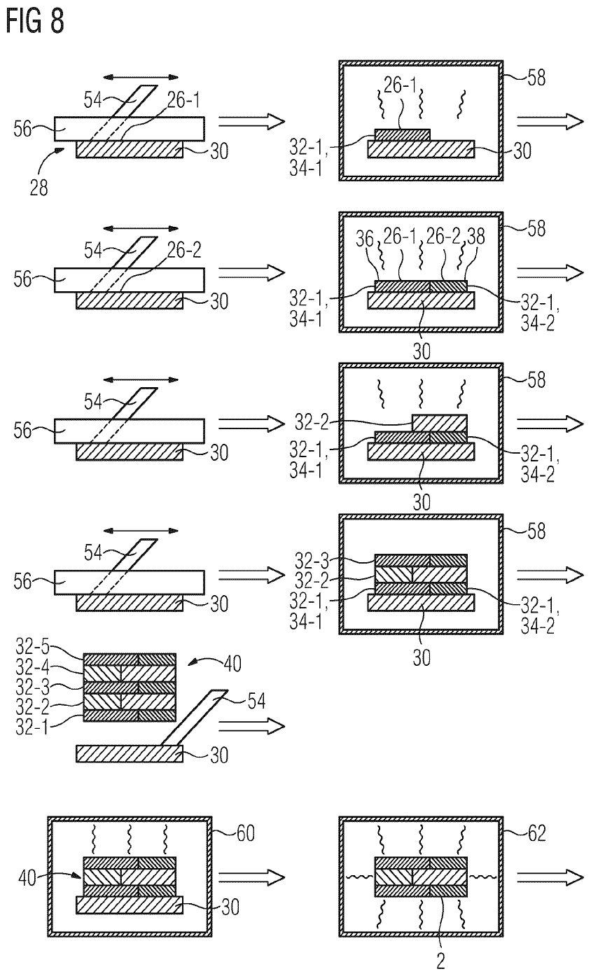

The following text addresses both the finished magnetic lamination 2, as illustrated for example in FIG. 2, and the production method depicted in FIG. 8 for the magnetic lamination 2. The characteristic features of the magnetic lamination 2, in particular of the layered structure and the material components used for this, are explained in more detail in FIGS. 3-7. The starting point used in FIGS. 3-7 is a finished magnetic lamination 2, but during the production there are also corresponding features of layers and of individual material components that become the final features only through the manufacturing process. In this respect, different designations are used.

FIGS. 3-5 make use of the designations that are relevant for the magnetic lamination and used after them in parentheses are the reference signs that correspond to them as precursors of these final features in the green body during the production of the magnetic lamination 2. Thus, the magnetic lamination 2 according to FIG. 3 has seven layers 8-1 to 8-7 overall. These layers 8-1 to 8-7 correspond to layers during the production of the magnetic lamination 2, which are designated by 32-1 to 32-7 in parentheses. Thus, the bottommost layer 8-1 has a radially inner region 10-1, which corresponds to a radially inner print region 36 during the stencil printing method 28. The layer 8-1 also has a second material component 10-2, which corresponds to a radially outer print region 38. The layer 8-1 has a thickness 24 of approximately 30 μm. Usually, the layer thicknesses 24 are between 10 μm and 80 μm.

The second layer 8-2 in turn has a first material component 10-1 and a second material component 10-2. This applies sequentially to the further layers 8-3 to 8-7. In the process, a plane of symmetry 12 running parallel to the lamination plane in the center of the magnetic lamination 2 is defined. In the center of the magnetic lamination 2 means in this case that it runs at half the height 64 of the magnetic lamination 2 parallel to the lamination plane, i.e. the lamination surface or a substrate face (cf. FIG. 8). The arrangement of the first material component 10-1 and of the second material component 10-2 is symmetrical above and below the plane of symmetry 12. The contents of the first material component 10-1 and 10-2 also vary in each layer 8-1 to 8-7. By virtue of these two measures, both the symmetry along the axis of symmetry 12 and the variation in each plane 8-1 to 8-7, the individual coefficients of thermal expansion of the individual material components 10-1 and 10-2 are adapted to one another such that the material stresses that arise in particular on a sintering shrinkage are considerably reduced. Moreover, as a result of the symmetrical arrangement of the layers 8-1 to 8-7, the magnetic lamination has little tendency to bulging and leads to a higher planarity of the magnetic lamination 2.

Also provided is a transition region 18 (provided with the term transition print region in the green body), in which both the first material component 10-1 and the second material component 10-2 occur throughout the magnetic lamination 2. This transition region likewise serves, as already described, to dampen and minimize the effect of the different coefficients of expansion of the individual material components 10-1 and 10-2.

The material component 10-1 may include a chromium-nickel alloy, which for example comprises 25% by weight chromium and thus has a nickel content of 7% by weight. Such an alloy is a stainless-steel alloy with a very high strength. This material component 10-1, which forms the radially inner region 14 of the magnetic lamination 2, bears responsibility in particular as support structure for the strength of the magnetic lamination 2, in particular at high rotational speeds. By contrast, the material component 10-2 is in the form of a magnetic material component, in particular a soft-magnetic component. It has a very high iron content of preferably above 95% by weight, very particularly preferably above 99% by weight. Such a high iron content, in the ideal case pure iron, leads to a ferritic material structure, which has particularly good soft-magnetic properties. This pure-iron structure can have its magnetization reversed very easily, the hysteresis losses on reversal of the magnetization of the material being very low.

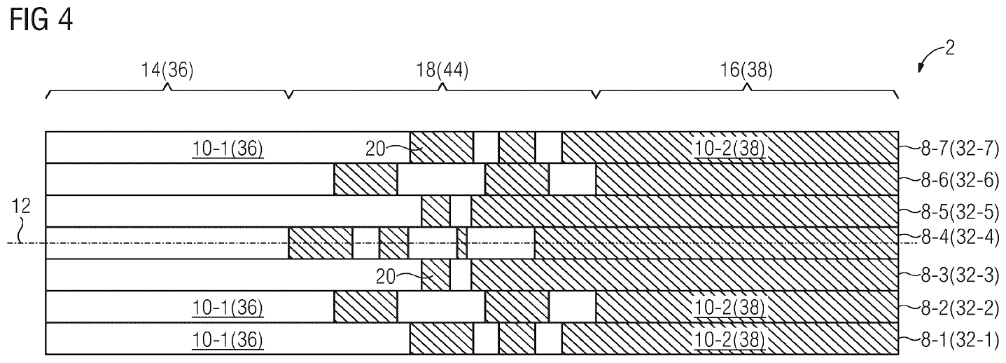

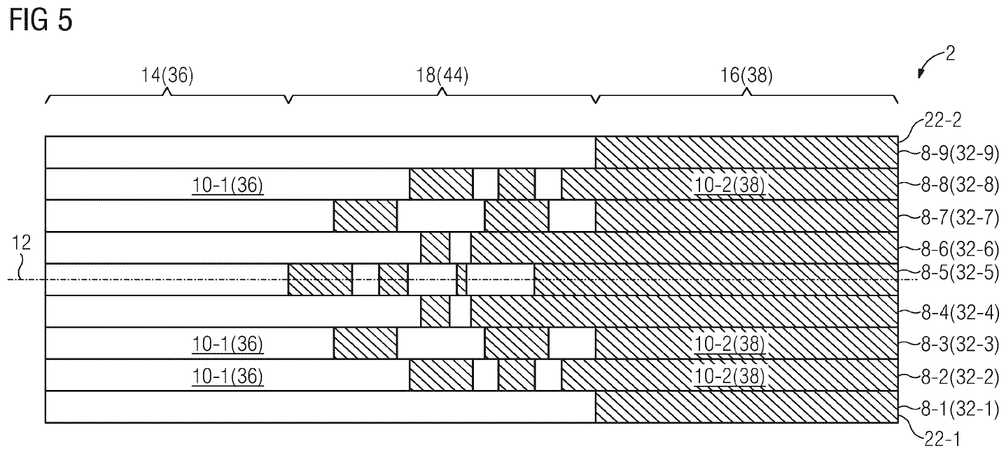

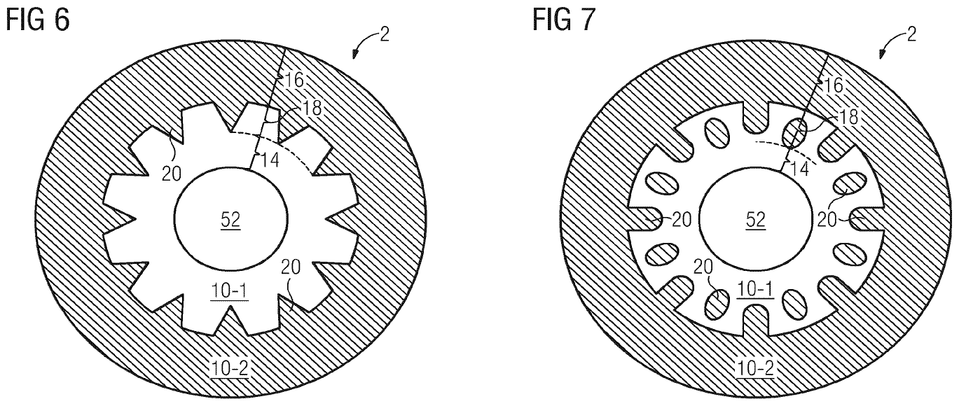

FIGS. 4 and 5 illustrate alternative embodiments of the magnetic lamination to the extensively described structure of the magnetic lamination 2 in FIG. 3. The essential difference of FIGS. 4 and 5 with respect to the structural composition of the magnetic lamination 2 according to FIG. 3 is that the transition region 18 is wider than in FIG. 3 and that it comprises multiple island-like discrete subregions 20, the second material component 10-2 with the soft-magnetic properties being embedded in material regions of the material component 10-1. This can also be seen in another illustration in FIGS. 6 and 7, each of which is a plan view of the magnetic lamination 2. In particular in FIG. 7, discrete subregions 20 of the material component 10-2 are embedded in the material component 10-1 in the manner of islands. By virtue of these discrete subregions 20 located in the transition region 18, it is possible in particular in the transition region 18 to address the different coefficients of thermal expansion. During the construction of the magnetic lamination 2, finite element methods can be used to calculate a corresponding distribution of the discrete subregions 20 in the transition region 18, with the result that the alignment of the coefficients of thermal expansion between the material components 10-1 and 10-2 is optimized.

The illustration of the magnetic lamination 2 in FIG. 5 differs from the illustration in FIG. 4 in particular in that a lower outer layer 22-1 and an upper outer layer 22-2 are provided, in which only the radially inner region 14 and the radially outer region 16 are present, and the transition region 18, which is in the layers in between, i.e. in this case the layers 8-2 to 8-8, is covered. In this case, the soft-magnetic material component 10-2 is covered by the first material component 10-1, and this results in magnetic shielding. This reduces eddy current losses.

As already described, FIGS. 6 and 7 depict plan views of the magnetic lamination 2, with in particular the transition region 18 varying between the two FIGS. 6 and 7. In this case, the magnetic lamination 2 has a bore 52, which is in the center of the magnetic lamination 2 and through which the shaft 50 is guided in an installation position.

FIG. 8 then depicts the production method, or a possible way of producing the magnetic lamination 2 with the described layer structure. It shows schematically very simplified images which are merely intended to better depict the individual process steps. Firstly, starting from the top left in FIG. 8, a stencil printing method 28 is used to create a first layer 32-1 of a green body 40 to be produced. In the process, a printing stencil 56, which in this example is in the form of a screen printing stencil 56, is used to print a first printing paste 26-1 onto a substrate 30 by means of a squeegee 54. The top right part shows how the first printing paste 26-1 on the substrate 30 is dried in a drying apparatus 58. The drying apparatus 58 may be a drying oven, for example it may be in the form of a roller-guided continuous oven, but it may also be a chamber in which drying takes place by infrared illumination.

In a further step, a second printing paste 26-2 is applied to the same substrate with another stencil 56′. The two printed printing pastes 26-1 and 26-2 form a first print region 34-1 and a second print region 34-2, respectively. Together, these print regions 34-1 and 34-2 form a first layer 32-1 of a green body 40. These print regions 34-1 and 34-2 directly adjoin one another without overlapping, apart from process inaccuracies. In the purely schematic illustration according to FIG. 8, in this case the detailed structure of the layers 32-1 to 32-7, as described in FIGS. 3 to 5, is not addressed. The starting point here is only a first print region 34-1 and a second print region 34-2. The radially inner print regions 36 and radially outer print regions 38 are only indicated in this simplified illustration. Further analogous processes, in which multiple layers 32-1 to ultimately 32-5 are placed one on top of another by this printing method, follow in FIG. 8. In this case, the drying operation in the drying apparatus 58 can come after each individual partial printing of a region 34-1 or 34-2, or after the twofold printing of a respective layer 32-n, for example 32-1. This reduces the process complexity, since it is not necessary to perform drying after each individual printing.

The green body 40, illustrated here for example with five layers 32-1 to 32-5, is then removed from the substrate 30 and fed to a further heat treatment. This involves firstly a binder-removal step, with in particular organic binders being thermally removed from the printing paste 26-1 and 26-2 in a binder-removing apparatus 60. The green body 40 prepared in this way is sintered in a further method step in a sintering apparatus 62 to afford the final magnetic lamination 2 at temperatures between 1000° C. and 1350° C. During the sintering operation, the individual grains, not illustrated here, of the iron alloys are connected to one another in the grain boundary regions by diffusion processes and to a small extent by melting processes, such that a monolithic microstructure is produced. The magnetic lamination 2 thus produced is described in FIGS. 3-7 and has the corresponding characteristic layer sequence and the resulting mechanical advantages.

### LIST OF REFERENCE SIGNS

2 Magnetic lamination
4 Laminated core
6 Electric machine
8-1-8-9 Layers
10-1, 10-2 Material components
12 Center plane=plane of symmetry
14 Radially inner region
16 Radially outer region
18 Transition region
20 Discrete subregions
22-1,2 Lower, upper outer layer
24 Layer thickness
26-1 First printing paste
26-2 Second printing paste
28 Stencil printing method
30 Substrate
32-1-32-9 Layers of green body
34-1,2 First print region, second print region
36 Radially inner print region
38 Radially outer print region
40 Green body
42 Sintering process
44 Transition region
46 Discrete subregions of green body
48 Rotor
50 Shaft
52 Bore
54 Squeegee
56 Printing stencil
58 Drying apparatus
60 Binder-removing apparatus
62 Sintering apparatus
64 Height of magnetic laminations

What is claimed is:

1. An additively produced magnetic lamination for a laminated core of an electric machine, the lamination comprising:
at least three layers connected by sintering, wherein each layer contains at least two material components separate from one another in planar extent,
wherein the arrangement of the material components in their planar extent in a respective layer is symmetrical to a center plane of the magnetic lamination;
a ratio of material contents of the first material component and of the second material component is modified over the layer sequence;
the first material component is arranged in a radially inner region of the respective layer and the second material component is arranged in a radially outer region of a respective layer; and
the first material component comprises an iron alloy with an austenitic microstructure of at least 25% by volume.

2. The magnetic lamination as claimed in claim 1, wherein the second material component comprises an iron alloy with at least 95% by weight iron.

3. The magnetic lamination as claimed in claim 2, wherein the second material component has a ferritic or martensitic microstructure.

4. The magnetic lamination as claimed in claim 1, wherein the first material component comprises a chromium-nickel alloy.

5. The magnetic lamination as claimed in claim 4, wherein the first material component comprises an iron-chromium alloy with a chromium content of between 22% by weight and 28% by weight.

6. The magnetic lamination as claimed in claim 4, wherein the first material component has a nickel content between 4% by weight and 10% by weight.

7. The magnetic lamination as claimed in claim 1, wherein at least one of the at least three layers has a transition region between the respective radially inner region and the respective radially outer region, the transition region including both the first material component and the second material component in discrete subregions.

8. The magnetic lamination as claimed in claim 7, wherein a lower outer layer and an upper outer layer of the magnetic lamination are each formed only by the radially inner region and by the radially outer region.

9. The magnetic lamination as claimed in claim 1 wherein the individual layers of the magnetic lamination have different layer thicknesses.

10. The magnetic lamination as claimed in claim 1, wherein individual layers each have a layer thickness between 10 μm and 80 μm.

11. A method for producing a rotationally symmetrical magnetic lamination for a laminated core of an electric machine, the method comprising:
a) applying a first printing paste by a stencil printing methods to a substrate to form a first region of a first layer;
b) applying a second region of the first layer to the substrate using a second printing paste, forming a radially inner print region and a radially outer print region;
c) repeating a) and c) to produce at least three layers forming a green body of the magnetic lamination;
wherein
the first printing paste and the second printing paste comprise different functional material starting components and the functional material starting components of the two printing pastes comprise iron particles in different alloy compositions; and
wherein the print regions in the individual layers are arranged to form a symmetry of the regions with respect to a center plane running parallel to the substrate through the middle of the green body and the material contents of the printing pastes vary between the individual layers; and
(d) sintering the green body to form the magnetic lamination so radially inner print regions having at least partially austenitic microstructure are converted into an iron-based material component in the magnetic lamination.

12. The method as claimed in claim 11, wherein, in addition to the radially inner print region and the radially outer print regions, transition print regions containing both the first material starting component and the second material starting component in discrete subregions are formed in at least two of the at least three layers.

13. The method as claimed in claim 11, further comprising applying at least one material component in the transition print region by a printing-free additive manufacturing method.

14. A laminated core for a rotor of an electric machine, the laminated core comprising:
a plurality of magnetic laminations, each lamination comprising:
at least three layers connected by sintering, wherein each layer contains at least two material components separate from one another in planar extent;
wherein the arrangement of the material components in their planar extent in a respective layer is symmetrical to a center plane of the magnetic lamination;
a ratio of material contents of the first material component and of the second material component is modified over the layer sequence;
the first material component is arranged in a radially inner region of the respective layer and the second material component is arranged in a radially outer region of a respective layer; and
the first material component comprises an iron alloy with an austenitic microstructure of at least 25% by volume.

15. (canceled)
